(19) United States
(12) Patent Application Publication
(10) Pub. No.: US 2008/0030118 A1
(43) Pub. Date: Feb. 7, 2008

(54) Electrodeless lamp system

(76) Inventor: Byung Il Ham, Rancho Pales Verdes, CA (US)

Correspondence Address: Walter T. Kim, Suite 1300, 2030 Main Street, Irvine, CA, 92614, US

(21) Appl. No.: 11/500,191

(22) Filed: Aug. 7, 2006

(51) Int. Cl. H01J 5/48; H01J 5/50

(52) U.S. Cl. 313/318.01; 313/318.12; 313/49

(57) ABSTRACT

An electrodeless lamp system includes a ballast assembly and a lamp envelope assembly. The ballast assembly includes a ballast circuit and ballast circuit contacts coupled to the ballast circuit. The lamp envelope assembly including a tubular lamp envelope, at least one core, an induction coil wounded around the at least one core, and contact terminals coupled to the induction coil. The electrodeless lamp system further includes a mounting mechanism to releasably connect the lamp envelope assembly to the ballast assembly.

### BACKGROUND OF THE INVENTION

1. Field of the Invention

The present invention generally relates to electrodeless lamps and to mounting assembly for electrodeless lamps.

2. Description of the Related Art

Various types of electrode lamps are available that have lamp electrodes disposed within a lamp envelope to deliver electrical power to the lamp. For example, in electrode type fluorescent lamps, electrical power is delivered to a fluorescent lamp through electrical power flowing between the lamp electrodes. Because electrode type lamps, such as compact fluorescent lamps (CFLs) and incandescent lamps, tend to be relatively light in terms of weight, they can be supported by a screw-in type base. Accordingly, such electrode type lamps are relatively easy to install by simply screwing in the base of the lamp in a lamp socket.

Recently, there have been introduced various types of electrodeless lamps that do not require electrodes disposed within the lamp envelope. One of the advantages of not using electrodes in electrodeless type lamps is that the life of the lamp can be substantially extended since the use of an electrode is a major factor in limiting the life of electrode type lamps. One drawback with conventional electrodeless lamps is that they are usually more difficult to install due to their weight and large size. In particular, because the electrodeless type lamps tend to be heavy in weight and large in size, they are not usually configured with screw-in type bases. Consequently, installing such electrodeless lamps can be a costly and labor-intensive process. Additionally, maintaining and/or replacing the burned out lamp envelope portion of the lamp can be cumbersome and unpleasant experience.

### BRIEF SUMMARY OF EMBODIMENTS THE INVENTION

Described herein are various embodiments of an electrodeless lamp system including a tubular lamp envelope having at least one core coupled to the tubular lamp envelope.

In an aspect of the present invention, at least one embodiment is directed to an electrodeless lamp system including a tubular lamp envelope having a first ferrite core and a second ferrite core encircling the tubular lamp envelope at a first location and a second location, respectively. In an embodiment, the electrodeless lamp system further includes a mounting assembly having a frame member coupled to the first and second ferrite cores and a base member attachable to a structure. The frame member includes connector elements to releasably engage with the base member such that the tubular lamp envelope attached to the frame member can be supported by the base member.

In another aspect of the present invention, at least one embodiment is directed to an electrode lamp assembly that is configured to protect a thin elongated tubular portion extending outward from the tubular lamp envelope. This is accomplished employing the frame member attached to the tubular lamp envelope to surround the thin elongated tubular portion from at least three sides. More specifically, the frame member comprises a first frame section fixedly attached to the first core and the second core encircling the tubular lamp envelope and a second frame section that oriented substantially perpendicular to the first frame section. In particular, the second frame section is formed by a top plate, a vertical plate extending downward from the top plate and two side plates extending from side edges of the vertical plates in a spaced-apart parallel relationship with respect to each other. The vertical plate and the side plates of the second frame section serve to protect the thin elongated tubular portion enclosed therein.

In yet another aspect of the present invention, at least one embodiment is directed to a mounting assembly for use with an electrodeless lamp system. The mounting assembly generally comprises a base member attachable to a structure such as, for example, a wall or a ceiling of a building, and a frame member attachable to a first ferrite core and a second ferrite core encircling a tubular lamp envelope. In accordance with one embodiment, the frame member is configured to releasably engage the base member such that the tubular lamp envelope attached to the frame member can be supported by the base member. In an embodiment, the base member of the mounting assembly is configured to contain the ballast circuit. In other words, in an embodiment, the base member serves dual purposes, first to house the ballast circuit and second to serve as a base structure to which the tubular lamp envelope can be detachably supported. In an embodiment, the frame member comprises a first frame section and a second frame section oriented substantially perpendicular to the first frame section. The second frame section has a pair of connector elements to removably attach to a pair of keyhole slots formed in the base member.

In an embodiment, the base member is provided with a number of sets of connector receiving arrangements such that the frame member attached to the tubular lamp envelope can be attached in a number of different orientations with respect to the base member. Accordingly, in one embodiment, the base member includes at least two face plates (e.g., a first face plate and a second face plate). Each of the face plates is provided with a set of connector receiving arrangements to releasably engage the connector element of the frame member such that the tubular lamp envelope attached to the frame member can supported by one of the respective face plates of the base member.

In a further aspect of the present invention, at least one embodiment is directed to a method of mounting an electrode lamp assembly. The method comprises attaching a frame member to a first ferrite core and a second ferrite core encircling a tubular lamp envelope of the electrodeless lamp. Then, the method comprises mounting a base member to a structure such as, for example, a wall or a ceiling of a building. Once the base member has been securely mounted, the method comprises detachably attaching the frame member to the base member such that the tubular lamp envelope attached to the frame member is supported by the base member.

In another further aspect of the present invention, at least one embodiment is directed to an electrodeless lamp system that comprises a lamp socket assembly and a lamp envelope assembly. The lamp socket assembly includes a socket mounting element, a ballast circuit and socket contacts coupled to the ballast circuit. The lamp envelope assembly includes a tubular electrodeless lamp envelope, at least one core coupled to the lamp envelope, an induction coil wounded around the at least one core, a lamp mounting element, and contact terminals coupled to the induction coil. In an embodiment, the lamp mounting element is adapted to releasably engage the socket mounting element such that the contact terminals of the lamp envelope assembly establishes electrical contact with the sockets contacts of the lamp socket assembly.

### BRIEF DESCRIPTION OF THE DRAWINGS

Embodiments of the invention are illustrated by way of example and not by way of limitation in the figures of the accompanying drawings in which like references indicate similar elements. It should be noted that the references to “an embodiment” or “one embodiment” of this disclosure are not necessarily to the same embodiment, and such references mean at least one.

FIG. 1A is a top plan view of a lamp envelope assembly according to an embodiment of the present invention.

FIG. 1B is a bottom plan view of the lamp envelope assembly of FIG. 1A.

FIG. 1C is a side elevational view of the lamp envelope assembly of FIG. 1A.

FIG. 1D is a side elevational view of a bracket according to an embodiment of the present invention.

FIG. 1E is a front view of the bracket of FIG. 1D.

FIG. 2A is a top plan view of a lamp envelope assembly according to an embodiment of the present invention.

FIG. 2B is a bottom plan view of the lamp envelope assembly of FIG. 2A.

FIG. 2C is a side elevational view of the lamp envelope assembly of FIG. 2A detached from a bracket according to an embodiment of the present invention.

FIG. 2D is a front view of the bracket in FIG. 2C.

FIG. 3A is a side elevational view of an electrodeless lamp system according to an embodiment of the present invention.

FIG. 3A is a top plan view of the electrodeless lamp system according to an embodiment of the present invention.

FIG. 4 is a side elevational view of an electrodeless lamp system mounted to a standing light structure according to an embodiment of the present invention.

FIG. 5A is a side elevational view of an electrodeless lamp system illustrating a lamp envelope assembly detached from a lamp socket according to a second embodiment of the present invention.

FIG. 5B is a side elevational view of the electrodeless lamp system according to the second embodiment of the present invention.

FIG. 5C is a side elevational view of an electrodeless lamp system illustrating a ballast housing mounted is a vertical or horizontal configuration according to the second embodiment of the present invention.

FIG. 6A is a side elevational view of an electrodeless lamp system illustrating a lamp envelope assembly detached from a lamp socket according to a third embodiment of the present invention.

FIG. 6B is a side elevational view of the electrodeless lamp system of FIG. 6A according to the third embodiment of the present invention.

FIG. 7 is a side elevational view of an electrodeless lamp system illustrating a lamp envelope assembly detached from a lamp socket according to a fourth embodiment of the present invention.

FIG. 8 is a side elevational view of an electrodeless lamp system illustrating a lamp envelope assembly detached from a lamp socket according to a fifth embodiment of the present invention.

FIG. 9A is a top plan view of a lamp envelope assembly according to a sixth embodiment of the present invention.

FIG. 9B is a side elevational view of the lamp envelope assembly in FIG. 9A.

### DETAILED DESCRIPTION OF THE INVENTION

In the following description, specific details are set forth in order to provide a thorough understanding of various embodiments of the present invention. However, it will be apparent to one skilled in the art that embodiments of the present invention may be practiced without these specific details. In other instances, well-known circuits, components, structures and techniques have not been shown in detail in order to avoid obscuring embodiments of the present invention. It should be noted that, as used in the description herein and the claims, the meaning of “in” includes “in” and “on”.

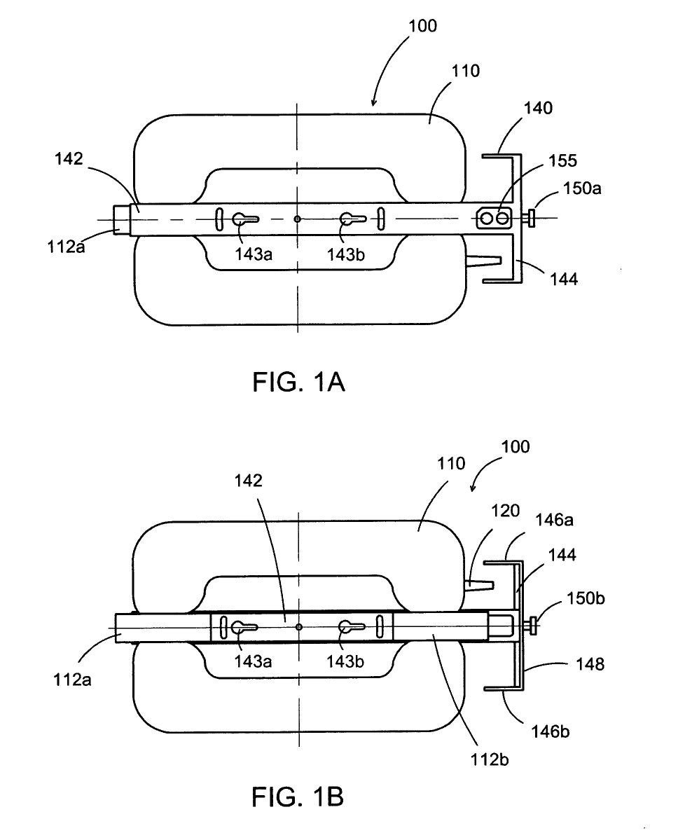

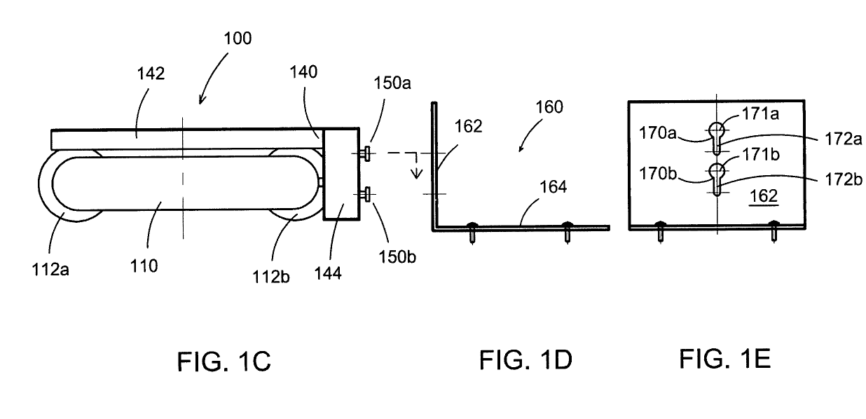

FIGS. 1A through 1C illustrate a lamp envelope assembly 100 according to an embodiment of the present invention. The illustrated lamp envelope assembly 100 generally includes a tubular lamp envelope 110, one or more ferrite cores 112a, 112b encircling the lamp envelope, an induction coil wounded around cores and a mounting frame member 140.

The tubular lamp envelope 110 is shaped in a closed loop. The tubular lamp envelope may contain a medium (e.g., argon gas, krypton gas, mercury vapor, etc) capable of generating ultraviolet (UV) radiation. The tubular lamp envelope 110 may include a layer of phosphors disposed on the inner surface thereof to convert the UV radiation into visible light. In an embodiment, the lamp assembly includes a thin tubular portion 120 (also referred to herein as “elongated tubular portion”) extending outward from the tubular lamp envelope 110. The thin tubular portion 120 has a closed end. In an embodiment, the thin tubular portion 120 is configured to control the mercury vapor pressure inside the lamp envelope.

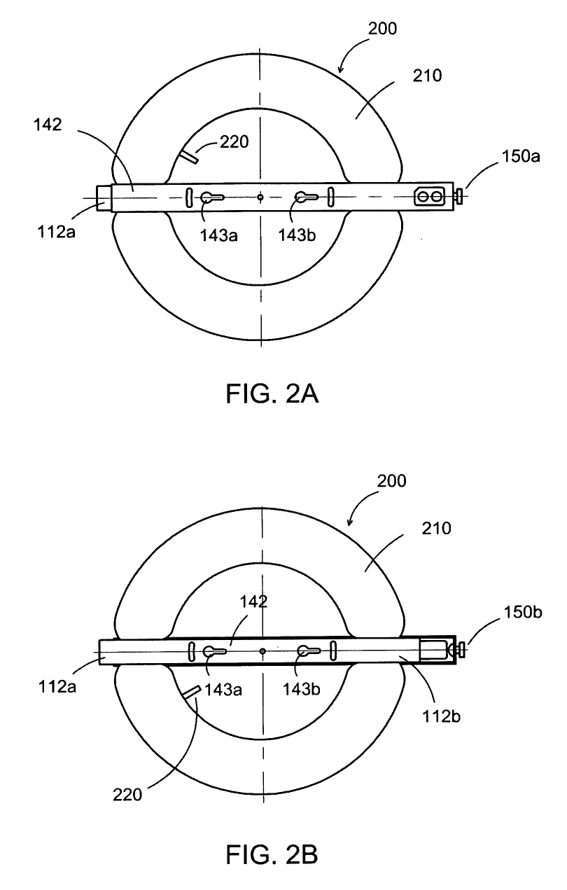

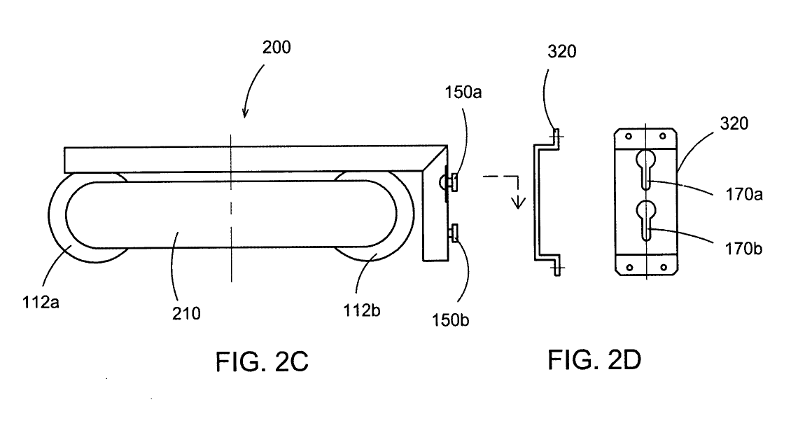

While the tubular lamp envelope 110 illustrated in FIGS. 1A through 1C has an overall rectangular shape, the lamp envelope assembly 100 can employ a tubular lamp envelope having any other suitable shape or size. For example, a lamp envelope assembly 200 illustrated in FIGS. 2A through 2C has a circular shaped lamp envelope 210 according to an embodiment of the present invention.

The power to generate light is transferred from the outside of the lamp envelope 110 by use of electromagnetic fields. In addition to the lamp envelope assembly 100, the electrodeless lamp system includes a ballast circuit to drive the induction coil wounded around the ferrite cores.

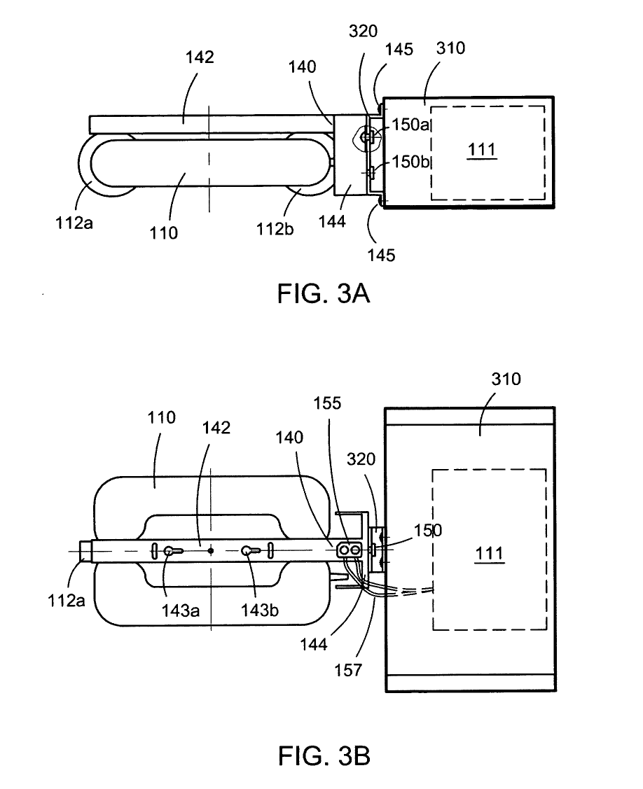

As shown in FIGS. 3A and 3B, in one embodiment, a ballast circuit 111 is contained in a ballast assembly (also referred to herein as “ballast housing”) 310 that is separate from the lamp envelope assembly 100. The ballast circuit 111 is configured to generate high frequency power (e.g. high frequency current) to drive the induction coils wound around each of the coils 112a, 112b. The ballast circuit 111 is capable of electrically connecting with the lamp envelope assembly 100 by removably connecting to an electrical connector 155 provided thereon via an electrical plug 157 extending from the ballast circuit. The electrical plug 157 extending from the ballast circuit includes ballast circuit contacts to establish electrical contact with contact terminals of the connector 155 provided on the lamp envelope assembly.

In operation, the high frequency current generated by the ballast circuit 111 flows through the induction coil wound around the ferrite cores 112, producing inductive electromagnetic fields to excite and maintain the interaction between the discharge gas (e.g., electrons, phosphors) contained in the lamp envelope 110.

As illustrated in FIGS. 3A, 3B, 2C and 2D, attached to the ballast housing 310, serving as a base member, is a bracket 320 for detachably supporting the lamp assembly. The bracket 320 includes an elevated section and a pair of keyhole slots formed in the elevated section. In accordance with one embodiment, the ballast housing 310 (also referred to herein as “base member”) serves dual purposes, first to house the ballast circuit 111 and second to serve as a base structure to which the lamp envelope assembly 100, 200 can be detachably supported. The ballast housing 310 can be mounted directly to a wall or a ceiling of a building to support the weight of the electrodeless lamp system. Alternatively, the ballast housing 310 can be supported by a structure that is mounted to a wall or a ceiling of a building.

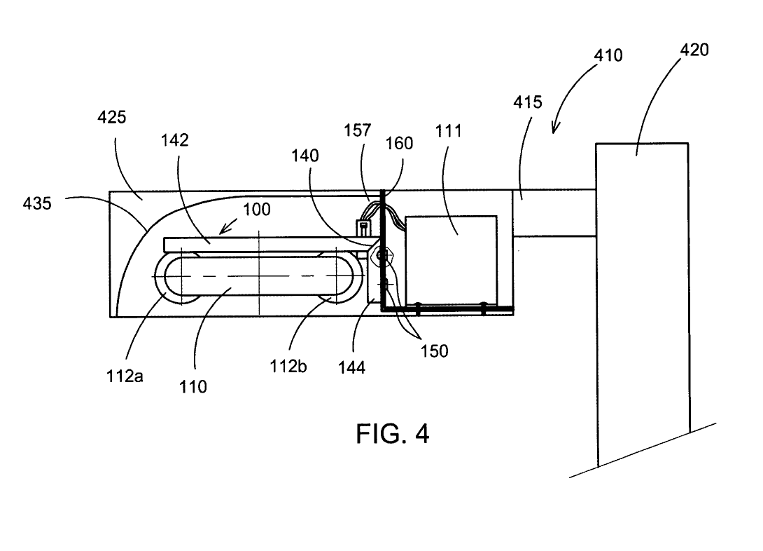

Other suitable bracket configurations may be employed. For example, an L-shaped bracket 160 can be utilized for detachably supporting the lamp assembly as illustrated in FIGS. 1D and 1E. The bracket 160 is formed of a vertical bracket section 162 and a horizontal bracket section 164. As seen by referring to FIG. 1 E, keyhole slots 170a, 170b are formed in the vertical bracket section 162. Each respective keyhole slot 170a, 170b includes a circular opening section 171a, 171b, respectively and a narrower vertical slot section, 172a, 172b, respectively. In one embodiment, the bracket 160 is adapted for mounting directly to a structure of a building such as a wall or a ceiling. In another embodiment, the bracket 160 is adapted for mounting to a base member (e.g., base member containing the ballast circuit) that is mounted to a wall or a ceiling of a building. In yet another embodiment, the bracket 160 is adapted for mounting to a fixed structure (e.g., a standing street light structure) that is vertically supported on the ground, as shown in FIG. 4.

The mounting mechanism of the lamp system comprises frame member 140 configured to releasably support the lamp envelope assembly 100 to a base structure (e.g., ballast housing 310) as shown in FIGS. 3A and 3B.

In the illustrated embodiment, the frame member 140 has a generally L-shaped cross-section and includes first frame section 142 and second frame section 144, each of which includes releasably attachable arrangements to attach to a fixed structure. More specifically, the first frame section 142 is configured for attachment to the first core 112a and the second core 112b of the lamp envelope assembly 100. In one embodiment, the second frame section 144 is configured to removably attach to a fixed mounting structure, such as, the ballast housing 310 via the bracket 160 or bracket 320.

In particular, the second frame section 144 comprises a vertical frame plate 148 extending vertically downward from the first frame section 142 and two side face plates 146a, 146b extending downward in parallel and spaced-apart relationship from each other along opposite edges of the vertical frame plate 148. The second frame section 144 further comprises an optional top plate (not shown) formed on top edges of the vertical frame plate 148 and the side face plates 146a, 146b.

The second frame section 144 is capable of releasably engaging the bracket 320 or 160 such that the weight of the lamp envelope assembly 100 is supported by the ballast housing 310. In this regard, the second frame section 144 is provided with a pair of connector elements 150a, 150b to releasably engage to the pair of keyhole slots 171a, 171b formed in the bracket 320, 160 mounted to the ballast housing 310. Each connector element 150a, 150b includes a disk shaped head and a shaft. Each connector element 150a, 150b can be affixed to the frame member 140 by using any suitable fixedly attachment means such as a semi-spherical head secured to one end of the shaft to securely attached the connector element to the frame member in a way such that the disk shaped head is spaced apart from the outer surface of the second frame section 144.

During installation of the lamp envelope assembly 100 to the ballast housing 310, the head of each respective connector element 150a, 150b is passed through the circular opening section 171a, 171b of each respective keyhole slot 170a, 170b formed in the bracket 160, 320. Once the respective heads have been inserted in the keyhole slots 170a, 170b, the lamp envelope assembly 100 is lowered such that the shafts of each respective connector elements 150a, 150b slides into the respective narrower section 172a, 172b of the keyhole slots 170a, 170b. As such, the lamp envelope assembly 100 can be easily mounted and supported by a base mounting structure (e.g., ballast housing and bracket) as shown in FIG. 3A.

Alternatively, the first frame section 142 of the frame member 140 can be mounted to a wall or a ceiling of a building to support the weight of the lamp envelope assembly 100. To accomplish this, a ceiling mounting bracket (not shown) can be mounted to a ceiling. The ceiling mounting bracket may be provided with connector elements to releasably engage with coinciding connector receiving arrangements 143a, 143b provided on the first frame section 142. In the illustrated embodiment, the first frame section includes a pair of keyhole slots 143a, 143b arranged to receive connector elements on a mounting bracket mounted to a fixed structure (e.g., a ceiling of a building).

In accordance with one aspect of one embodiment, the mounting frame member 140 is configured to protect the thin tubular portion 120 extending from the lamp envelope 110. Typically, the lamp envelope 110 and the thin tubular portion 120 extending therefrom are constructed of glass material. Accordingly, the tubular portion 120 extending from the lamp envelope is fragile and can be broken off if it inadvertently makes contact with another physical object, which would render the lamp envelope assembly 100 inoperative. The protection of the thin tubular portion 120 is accomplished by employing the frame member 140 attached to the tubular lamp envelope 110 to surround the thin elongated tubular portion 120 from at least three sides. As described above, the second frame section 144 is formed by the top plate (not shown), the vertical plate 148 extending downward from the top plate and two side plates 146a, 146b extending from side edges of the vertical plate in a spaced-apart parallel relationship with respect to each other. The top plate, the vertical plate 148 and the side plates 146a, 146b forming the second frame section serve to protect the thin elongated tubular portion 120 enclosed therein.

In accordance with another aspect of an embodiment, the base member (e.g., ballast housing 310) is provided with a number of sets of connector receiving arrangements (e.g., mounting brackets). The plurality of mounting brackets are provided at different locations of the base member so that the lamp envelope assembly 100 can be attached in a number of different orientations with respect to the base member, depending on the desired placement of the lamp envelope assembly 100. Accordingly, in one embodiment, the base member (e.g., ballast housing 310) includes at least two face plates (e.g., a first face plate and a second face plate). Each of the face plates is provided with a set of connector receiving arrangements (e.g., mounting bracket) to releasably engage the connector elements 150a, 150b of the frame member 140 such that the lamp envelope assembly 100 can supported by any of the two or more respective face plates of the base member.

FIG. 4 illustrates an electrodeless lamp system for use with a standing light structure 410 according to an embodiment of the present invention. In one embodiment, the standing light structure functions as a street light. In another embodiment, the standing light structure is a free standing type indoor light structure. The standing light structure 410 includes a vertical pole structure which can be mounted in a ground or can be a part of a free standing lamp stand. Connected horizontally to the vertical pole 420 are a horizontal support member 415 and a cover 425. A reflector member 435 is provided inside the cover 425 to direct the light produced by the tubular lamp envelope in downward direction.

The electrodeless lamp system illustrated with respect to the FIG. 4 includes the lamp envelope assembly 100 in FIG. 1C and the bracket 160 in FIG. 1D. The electrodeless lamp system further includes a ballast assembly containing ballast circuit 111 supported by the horizontal plate of the bracket 160. The ballast circuit 111 is electrically coupled to the lamp envelope assembly 100 via an electrical plug 157 plugged into an electrical connector 140 provided on the lamp envelope assembly 100. As described above, the lamp envelope assembly 100 is releasably attached to the bracket 160 by engaging connector elements 150 through keyhole slots formed in the horizontal plate of the bracket 160.

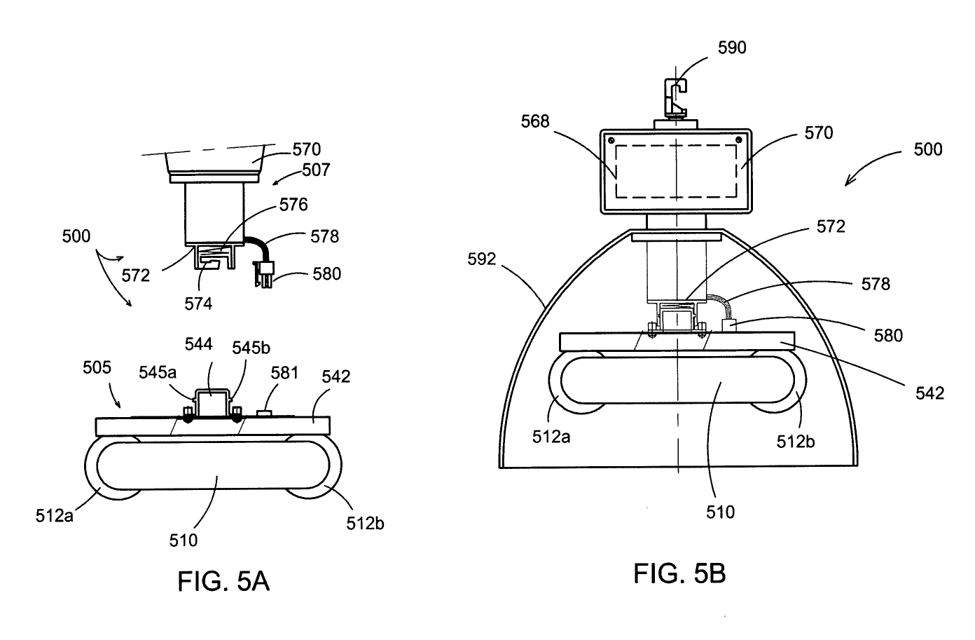

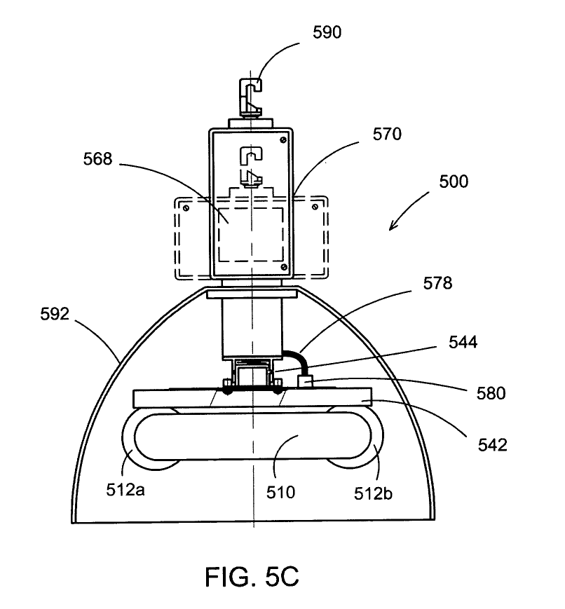

FIGS. 5A and 5B illustrate an electrodeless lamp system 500 according to a second embodiment of the present invention. The lamp system 500 generally includes a lamp envelope assembly 505 and a lamp socket assembly 507 (also referred to herein as “ballast assembly”). The lamp envelope assembly 505 includes a tubular lamp envelope 510, a pair of ferrite cores 512a, 512b encircling the lamp envelope, an induction coil wounded around cores, and a mounting frame member 542. The tubular lamp envelope 510 can have an overall rectangular configuration (as shown in FIG. 1A), a circular configuration (as shown in FIG. 2A) or any other suitable tubular lamp envelope configuration.

Attached to the mounting frame member 542 is a lamp mounting element 544. In an embodiment, the lamp mounting element 544 comprises a male mounting element 544 having a pair of pins 545a, 545b arranged to matingly engage the L-shaped slot 574 provided in a female mounting element 572 (also referred to herein as “socket mounting element”) provided on the lamp socket assembly 507. Also provided within the female mounting element 572 is a resilient member (e.g., spring) to apply downward pressure on the male mounting element 544 while they are engaged to firmly hold the lamp envelope assembly 505. The lamp socket assembly 507 includes a ballast housing 570 to contain a ballast circuit 568. The ballast circuit 568 can electrically connect with the lamp envelope assembly 505 by connecting an electrical plug 580 provided at one end of an electrically conductive line 578 to an electrical connector 581 provided on the lamp envelope assembly 505. More specifically, the electrical plug 580 includes ballast circuit contacts to establish electrical contact with contact terminals of the connector 581 provided on the lamp envelop assembly. The illustrated lamp system 500 further includes a hanging-type lamp shape 592 supported by the lamp socket assembly 507 and a hook member 590 for suspending the lamp system 500 on a ceiling mounting member.

FIG. 5C illustrates that the ballast housing can be mounted in either a vertical orientation or a horizontal orientation according to an embodiment of the present invention, depending on the desired overall height of the lamp system. The ballast housing can be mounted in the horizontal orientation to reduce the overall height of the lamp system.

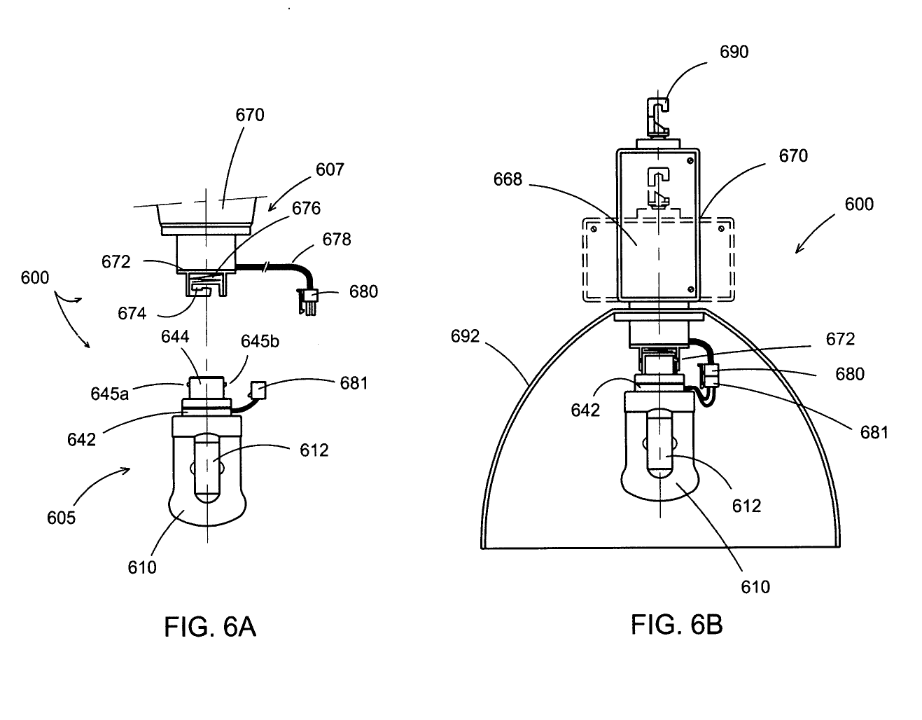

FIGS. 6A and 6B illustrate an electrodeless lamp system 600 according to a second embodiment of the present invention. The lamp system 600 comprises a lamp envelope assembly 605 and a lamp socket assembly 607 (also referred to herein as “ballast assembly”). The lamp envelope assembly 605 includes a lamp envelope 610 and a ferrite core 612 with an induction coil wounded around core. In one embodiment, the lamp envelope 610 is U-shaped and the ferrite core 612 with the induction coil winding is disposed between the two vertical portions of the lamp envelope 610. In another embodiment, the lamp envelope 610 is elongated donut shaped and the ferrite core 612 with the induction coil winding is disposed in the hole portion thereof.

The lamp envelope assembly 505 is supported by the housing 642. Attached to the housing 642 is a lamp mounting element 644. In an embodiment, the lamp mounting element 644 comprises a male mounting element 644 having a pair of pins 645a, 645b arranged to matingly engage the L-shaped slot 674 provided in a female mounting element 672 (also referred to herein as “socket mounting element”) provided on the lamp socket assembly 607. Also provided within the female mounting element 672 is a resilient member (e.g., spring) to apply downward pressure on the male mounting element 644 while they are engaged to firmly hold the lamp envelope assembly 605. The lamp socket assembly 607 includes a ballast housing 670 to contain a ballast circuit 668. The ballast circuit 668 can electrically connect with the lamp envelope assembly 605 by connecting an electrical plug 680 provided at one end of an electrically conductive line 678 to an electrical connector 681 provided on the lamp envelope assembly 605. More specifically, the electrical plug 680 includes ballast circuit contacts to establish electrical contact with contact terminals of the connector 681 provided on the lamp envelop assembly. The illustrated lamp system 600 further includes a hanging-type lamp shape 692 supported by the lamp socket assembly 607 and a hook member 690 for suspending the lamp system 600 on a ceiling mounting member.

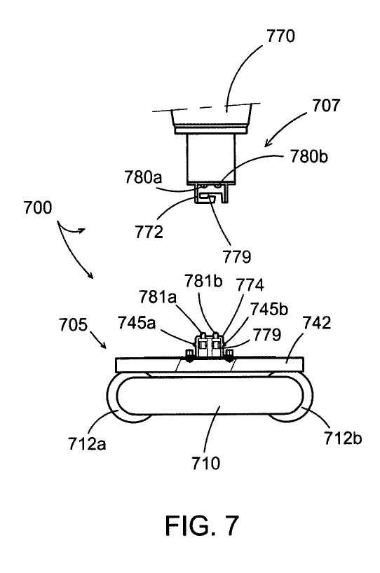

FIG. 7 illustrates an electrodeless lamp system 700 according to a third embodiment of the present invention. The lamp system 700 generally includes a lamp envelope assembly 705 and a lamp socket assembly 707 (also referred to herein as “ballast assembly”). The lamp envelope assembly 705 includes a tubular lamp envelope 710, a pair of ferrite cores 712a, 712b encircling the lamp envelope, an induction coil wounded around cores, and a mounting frame member 742. The tubular lamp envelope 710 can have an overall rectangular configuration (as shown in FIG. 1A), a circular configuration (as shown in FIG. 2A) or any other suitable tubular lamp envelope configuration.

Attached to the mounting frame member 742 is a lamp mounting element 774. In an embodiment, the lamp mounting element 774 comprises a male mounting element 774 having a pair of pins 745a, 745b arranged to matingly engage the L-shaped slot 779 provided in a female mounting element 772 (also referred to herein as “socket mounting element”) provided on the lamp socket assembly 707. Provided on the male mounting element 774 is a pair of contact terminals 781a, 781b that are electrically coupled to the inductive coil wounded around the cores 712a, 712b. The contact terminals 781a, 781b are configured to establish electrical contact with corresponding socket contacts (also referred to herein as “ballast circuit contacts”) 780a, 780b provided in the female mounting element 772.

The lamp socket assembly 707 includes a ballast housing 770 to contain a ballast circuit. The ballast circuit housed in the lamp socket assembly 707 can establish electrically connect with the lamp envelope assembly 705 by connecting the contact terminals 781a, 781b provided on the male mounting element 774 to the socket contacts 780a, 780b provided in the female mounting element 772. Also provided within the male mounting element 774 is resilient members (e.g., springs) coupled to the contact terminals 781a, 781b to apply upward pressure to the contact terminals 781a, 781b to establish firm contact the corresponding socket contacts 780a, 780b while the male mounting element 774 is firmly engaged in the female mounting element 772 to hold the lamp envelope assembly 705.

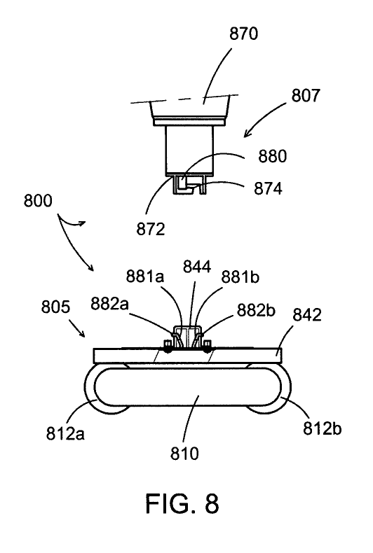

FIG. 8 illustrates an electrodeless lamp system 800 according to a fourth embodiment of the present invention. The lamp system 800 generally includes a lamp envelope assembly 805 and a lamp socket assembly 807 (also referred to herein as “ballast assembly”). The lamp envelope assembly 805 includes a tubular lamp envelope 810, a pair of ferrite cores 812a, 812b encircling the lamp envelope, an induction coil wounded around the cores, and a mounting frame member 842. The tubular lamp envelope 810 can have an overall rectangular configuration (as shown in FIG. 1A), a circular configuration (as shown in FIG. 2A) or any other suitable tubular lamp envelope configuration.

Attached to the mounting frame member 842 is a lamp mounting element 844. In an embodiment, the lamp mounting element 844 comprises a male mounting element 844 having a pair of contact terminals 881a, 881b. In the illustrated embodiment, the contact terminals are realized using contact springs 881a, 881b. The contact springs 881a, 881b include pin portions 882a, 882b that are arranged to matingly engage the L-shaped slot 874 provided in a female mounting element 872 provided on the lamp socket assembly 807 (also referred to herein as “socket mounting element”). The lamp socket assembly 807 includes a ballast housing 870 to contain a ballast circuit. The ballast circuit can electrically connect with the lamp envelope assembly 805 by connecting contact springs 881a, 881b provided on the male mounting element 844 to corresponding socket contacts 880 (also referred to herein as “ballast circuit contacts”) provided in the female mounting element 872.

The contact springs 881a, 881b are electrically coupled to the induction coil wounded around the cores and are adapted to resiliently press the pin portions 882a, 882b outward to contact the corresponding socket contacts 880 while the male mounting element 844 is firmly engaged in the female mounting element 872 to firmly hold the lamp envelope assembly 805. Accordingly, the contact springs 881a, 882 serve dual purposes; first purpose is to mechanically engage the mounting element of the lamp socket assembly 807, and second purpose is to establish electrical contact with the ballast circuit housed in the lamp socket assembly 807.

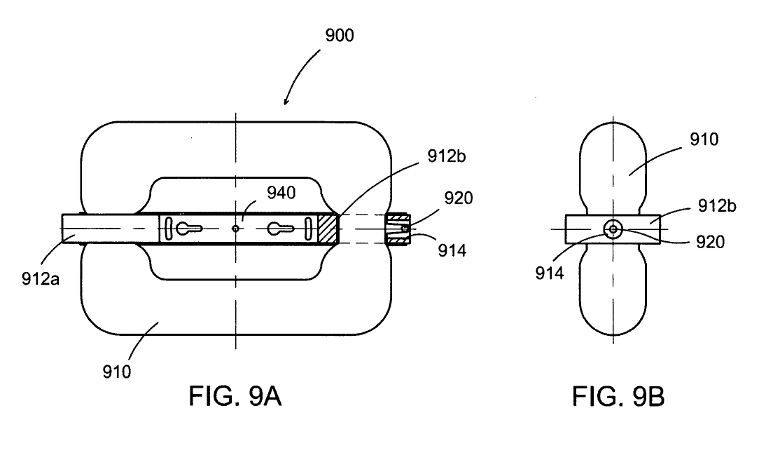

FIGS. 9A and 9B illustrate a lamp envelope assembly 900 according to a fifth embodiment of the present invention. The lamp envelope assembly 900 generally includes a tubular lamp envelope 110, a pair of ferrite cores 912a, 912b encircling the lamp envelope, an induction coil wounded around cores and a mounting frame member 940. It is noted that although the tubular lamp envelope 910 illustrated in FIG. 9A has an overall rectangular shape, the lamp envelope assembly 900 can employ a tubular lamp envelope having any other suitable shape or size, including generally circular or oval shaped lamp envelope. In the embodiment described with reference to FIG. 1A, the thin tubular portion 120 extending from the lamp envelope 110 is protected by the mounting frame member 140. In the embodiment illustrated in FIGS. 9A and 9B, the thin tubular portion 920 extending from the lamp envelope 910 is protected by one of the ferrite cores 912b. More specifically, in the illustrated embodiment, a hole or a recess 914 is provided in the ferrite core 912b. The hole or recess 914 is positioned to receive the thin tubular portion 920 (also referred to herein as “elongated tubular portion”) when the ferrite core 912b is mounted on the lamp envelope 910. Thus, during the manufacturing of the lamp envelope assembly 900, the ferrite core 912b is mounted on the lamp envelope 910 such that the thin tubular portion 920 is inserted in the hole 914 formed in the ferrite core 912b. By doing so, because the thin tubular portion 920 is surrounded by the core 912b, there is less chance of the thin tubular portion 920 from being damaged or being broken off caused by accidentally making contact with another physical object.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. An electrodeless lamp system comprising:
a ballast assembly including a ballast circuit and ballast circuit contacts coupled to the ballast circuit; and
a lamp envelope assembly including a tubular lamp envelope, at least one core, an induction coil wounded around the at least one core, and contact terminals coupled to the induction coil, the lamp envelope assembly configured to releasably connect to the ballast assembly.

2. The electrodeless lamp system of claim 1, wherein the at least core comprises a first ferrite core encircling the lamp envelope at a first location and a second ferrite core encircling the lamp envelope at a second location.

3. The electrodeless lamp system of claim 2,
wherein the lamp envelope assembly further comprises a lamp mounting element including a frame member coupled to the first core and the second core; and
wherein the ballast assembly includes a base member to contain the ballast circuit, wherein the frame member is capable of releasably mounting to the base member such that the tubular lamp envelope attached to the frame member is supported by the base member.

4. The electrodeless lamp system of claim 3, wherein the frame member comprises:
a first frame section attached to the first core and the second core; and
a second frame section connected to the first frame section, the second frame section having at least one connector element to removably attach to the base member.

5. The electrodeless lamp system of claim 3,
wherein the frame member includes a pair of connector elements, each of the connector elements including a head section and a shaft section; and
wherein the base member includes a face plate having a pair of keyhole slots formed in the face plate, the keyhole slots are positioned to receive the respective head sections of the respective connector elements.

6. The electrodeless lamp system of claim 3,
wherein the frame member includes at least one connector element; and
wherein the base member includes a first face plate and a second face plate, the first face plate is capable of releasably engaging the connector element of the frame member such that the tubular lamp envelope attached to the frame member is supported by the base member, the second face plate is capable of releasably engaging the connector element of the frame member such that the tubular lamp envelope attached to the frame member is supported by the base member.

7. The electrodeless lamp system of claim 3,
wherein the tubular lamp envelope includes an elongated tubular portion extending therefrom; and
wherein the frame member is configured to cover the tubular portion from at least two sides.

8. The electrodeless lamp system of claim 1,
wherein the tubular lamp envelope includes an elongated tubular portion extending therefrom; and
wherein the core has a recess to receive the elongated tubular portion.

9. The lamp system of claim 1,
wherein the ballast assembly includes a socket mounting element; and
wherein the lamp envelope assembly includes a lamp mounting element having a pair of pins arranged to matingly engage slots of the socket mounting elements.

10. The lamp system of claim 1,
wherein the ballast assembly includes a socket mounting element; and
wherein the lamp envelope assembly includes a lamp mounting element configured to releasably engage the socket mounting element such that the contact terminals of the lamp envelope assembly establishes electrical contact with the ballast circuit contacts of the ballast assembly.

11. The lamp system of claim 10, wherein the contact terminals comprise contact springs including pin portions that are arranged to matingly engage slots formed in the socket mounting element.

12. The electrodeless lamp system of claim 10, wherein the contact terminals are coupled to resilient members to apply pressure to the contact terminals to establish contact with the ballast circuit contacts while the lamp mounting element is firmed engaged by the socket mounting element.

13. An apparatus for use with an electrodeless lamp including a tubular lamp envelope and a first core and a second core disposed on the lamp envelope, the apparatus comprising:
a base member attachable to a structure; and
a frame member attachable to the first core and the second core disposed on the tubular lamp envelope, the frame member to releasably engage the base member such that the tubular lamp envelope attached to the frame member is supported by the base member.

14. The apparatus of claim 13,
wherein the frame member includes at least one connector element; and
wherein the base member is configured to releasably engage the connector element of the frame member such that the tubular lamp envelope attached to the frame member is capable of being supported by the base member.

15. The apparatus of claim 13,
wherein the frame member includes a pair of connector elements, each of the connector elements including a head section and a shaft section; and
wherein the base member includes a face plate having a pair of keyhole slots formed in the face plate, the keyhole slots are positioned to receive the respective head sections of the respective connector elements.

16. The apparatus of claim 13,
wherein the frame member includes at least one connector element; and
wherein the base member includes a first face plate and a second face plate, the first face plate is capable of releasably engaging the connector element of the frame member such that the tubular lamp envelope attached to the frame member is supported by the base member, the second face plate is capable of releasably engaging the connector element of the frame member such that the tubular lamp envelope attached to the frame member is supported by the base member.

17. The apparatus of claim 13, wherein the frame member comprises:
a first frame section attachable to the first core and the second core; and
a second frame section oriented substantially perpendicular to the first frame section, the second frame section having at least one connector element to removably attach to the base member.

18. The apparatus of claim 13,
wherein the tubular lamp envelope includes an elongated tubular portion extending from the tubular lamp envelope, the elongated tubular portion having a closed end; and
wherein the second frame section surrounds the elongated tubular portion from at least three sides.

19. The apparatus of claim 13, wherein the base member is configured to contain a ballast circuit that drives a coil coupled to the core of the electrodeless lamp assembly.

20. An electrodeless lamp system comprising:
a lamp socket assembly including a socket mounting element, a ballast circuit and socket contacts coupled to the ballast circuit; and
a lamp envelope assembly including a tubular electrodeless lamp envelope, at least one core, an induction coil wounded around the at least one core, a lamp mounting element, and contact terminals coupled to the induction coil, the lamp mounting element configured to releasably engage the socket mounting element.

21. The electrodeless lamp system of claim 20, wherein the lamp mounting element is provided with a pair of pins arranged to matingly engage slots of the socket mounting elements.

22. The electrodeless lamp system of claim 20, wherein the lamp mounting element is configured to releasably engage the socket mounting element such that the contact terminals of the lamp envelope assembly establishes electrical contact with the socket contacts of the lamp socket assembly.

23. The electrodeless lamp system of claim 22, wherein the contact terminals comprise contact springs including pin portions that are arranged to matingly engage slots formed in the socket mounting element.

24. The electrodeless lamp system of claim 20, wherein the contact terminals are coupled to resilient members to apply pressure to the contact terminals to establish contact with the socket contacts while the lamp mounting element is firmed engaged by the socket mounting element.
